(19) United States
(12) Patent Application Publication
(10) Pub. No.: US 2024/0344572 A1
(43) Pub. Date: Oct. 17, 2024

(54) DISK BRAKE CALIPER AND DISK BRAKE APPARATUS

(71) Applicant: HL MANDO CORPORATION, Pyeongtaek-si (KR)

(72) Inventor: Hatem SHAHIN, Pfaffenhofen (DE)

(73) Assignee: HL MANDO CORPORATION, Pyeongtaek-si (KR)

(21) Appl. No.: 18/241,701

(22) Filed: Sep. 1, 2023

(30) Foreign Application Priority Data
Apr. 12, 2023 (KR) 10-2023-0048045

(51) Int. Cl. F16D 65/00; F16D 55/226; F16D 65/847

(52) U.S. Cl. CPC F16D 65/0068; F16D 55/226; F16D 65/847; F16D 2055/0016

(57) ABSTRACT

A brake caliper housing in accordance with one aspect of the present disclosure includes a main body having a cylinder in which a piston is accommodated, a bridge extending from the main body in a lateral direction, and a finger portion extending downward from an end portion of the bridge, wherein a concave portion recessed inward to form a path through which air flows may be formed in a surface of the finger portion in contact with an outer pad assembly.

### CROSS-REFERENCE TO RELATED APPLICATION

This application claims the benefit of Korean Patent Application No. 10-2023-0048045, filed on Apr. 12, 2023 in the Korean Intellectual Property Office, the disclosure of which is incorporated herein by reference.

### BACKGROUND

### 1. Field

Embodiments of the present disclosure relate to a disk brake caliper and a disk brake apparatus, and more specifically, to a disk brake caliper of which a surface in contact with a pad is provided with a concave portion forming an air path to prevent drag and a disk brake apparatus.

### 2. Description of the Related Art

Braking systems are necessarily mounted in vehicles to perform braking, and various types of braking systems have been proposed for driver and passenger safety.

Among them, in a disc brake, one or more brake pads are in contact with a brake disc which rotates with a wheel of a vehicle and apply a pressure against the brake disc to perform braking. Such a brake pad is moved toward the brake disc by a piston. The brake piston may be moved by a hydraulic actuator or mechanical actuator.

After the braking is performed by the brake piston as described above, when the braking is released, the brake piston moves backward, and the brake pad is separated from the brake disc. However, when the brake pad does not fully return to its initial position, contact between the brake pad and brake disc may be maintained while the vehicle is traveling, and frictional resistance between the brake pad and the brake disc is generated to generate residual drag torque such as increases in wear of the brake pad, fuel consumption, and noise.

Although there is a method of installing a spring which applies a restoring force to the brake pad or the like to prevent the generation of the residual drag torque, there are problems that the number of components increases and the process becomes complicated.

### SUMMARY

Therefore, it is an aspect of the present disclosure to provide a disk brake caliper of which a surface in contact with a pad is provided with a concave portion forming an air path to prevent drag, and a disk brake apparatus.

In accordance with one aspect of the present disclosure, a brake caliper housing includes a main body having a cylinder in which a piston is accommodated, a bridge extending from the main body in a lateral direction, and a finger portion extending downward from an end portion of the bridge, wherein a concave portion recessed inward to form a path through which air flows is formed in a surface of the finger portion in contact with an outer pad assembly.

The concave portion may be provided with a path elongated in one direction and formed in the surface, and at least one end portion of the path may extend to an edge of the surface.

The concave portion may be provided with a path elongated in the lateral direction and formed in the surface.

The concave portion may be provided with two or more paths separated from each other and formed in the surface.

The concave portion may be provided with the two or more paths having shapes recessed in parallel.

The concave portion may be provided with the two or more paths having shapes recessed to have a predetermined angle therebetween.

The concave portion may be provided with the two or more paths having shapes recessed to have different widths and depths.

The surface of the concave portion may be provided with a lateral path having a shape recessed to elongate in the lateral direction and a downward path having a shape recessed to elongate in a downward direction from the lateral path.

The finger portion may be provided as a pair of finger portions disposed in parallel, and the concave portion may be provided with paths each formed in one of the pair of the finger portions.

The concave portions may be provided with paths having linearly symmetrical shapes and formed in the pair of the finger portions.

The concave portion may be provided with paths having different shapes formed in the pair of the finger portions.

The concave portion may be provided with separated paths of different numbers formed in the pair of the finger portions.

In accordance with one aspect of the present disclosure, a brake apparatus includes a caliper housing including a main body having a cylinder in which a piston is accommodated, a bridge extending in a lateral direction from the main body, and a finger portion extending downward from an end portion of the bridge and a carrier in which the caliper housing is installed to be moved forward and backward, wherein a concave portion recessed inward to form a path through which air flows is formed in a surface of the finger portion in contact with an outer pad assembly.

The brake apparatus may further include an inner pad assembly and the outer pad assembly installed in the carrier to be moved forward and backward.

The concave portion may be provided with a path elongated in one direction and formed in the surface, and at least one end portion of the path may extend to an edge of the surface.

The concave portion may be provided with two or more paths separated from each other and formed in the surface.

The finger portion may be provided as a pair of finger portions disposed in parallel, and the concave portion may be provided with paths each formed in one of the pair of the finger portions.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is an exploded perspective view illustrating a brake apparatus according to one embodiment of the present disclosure;

FIG. 2 is a cross-sectional view illustrating the brake apparatus according to one embodiment of the present disclosure;

FIG. 3 is a view illustrating a finger portion in which a concave portion is provided according to one embodiment of the present disclosure;

FIG. 4 is a view illustrating a path formed by a concave portion provided in a finger portion of a caliper housing according to one embodiment of the present disclosure;

FIG. 5 is a view illustrating a path according to a second embodiment of the present disclosure;

FIG. 6 is a view illustrating a path according to a third embodiment of the present disclosure;

FIG. 7 is a view illustrating a path according to a fourth embodiment of the present disclosure; and

FIG. 8 is a view illustrating a path according to a fifth embodiment of the present disclosure.

### DETAILED DESCRIPTION

Like reference numerals denote like elements throughout the specification. In the specification, all elements of embodiments are not described, and general contents in the art or repeated contents between the embodiments will not be described. Terms such as parts, modules, members, and blocks may be implemented using software or hardware, and a plurality of parts, modules, members, and blocks may be implemented in a single element, or one part, module, member, or block may also include a plurality of elements.

Throughout the specification, a case in which a first part is referred to as being “connected” to a second part includes a case of “directly connected” and “indirectly connected,” and a case of “indirectly connected” includes a case of “connected” to the second part through a wireless communication network.

In addition, when a part “includes” an element, another element may be further included, rather than excluding the existence of another element, unless otherwise described.

Terms such as first, second, and the like are used herein to distinguish one element from another element, and the elements are not limited to the above-described terms.

As used herein, singular forms “a” and “an” are intended to include the plural forms as well, unless the context clearly indicates otherwise.

Reference numerals in operations are used for the sake of convenience in description and do not describe an order of the operations, and the operations may be performed through an order different from the described order unless the context clearly indicates a specific order.

Operating principles and embodiments of the present disclosure will be described with reference to the accompanying drawings.

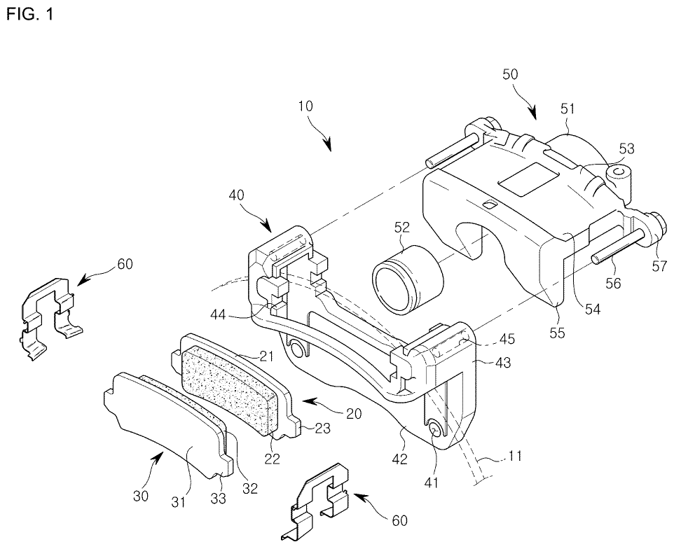

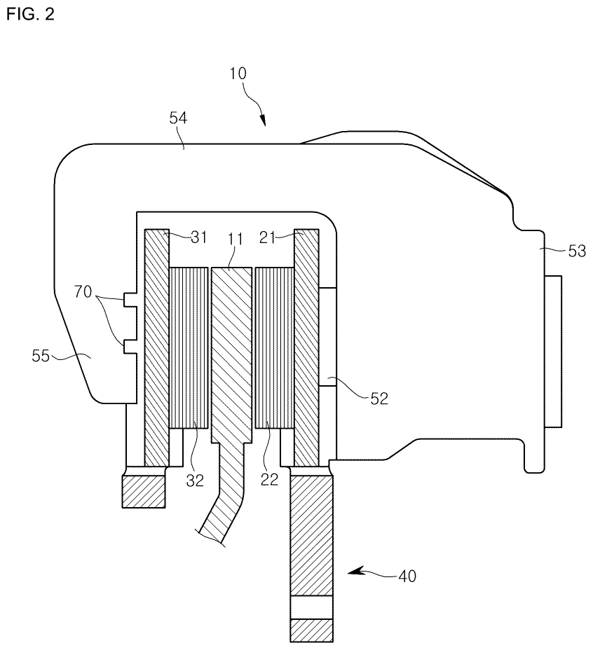

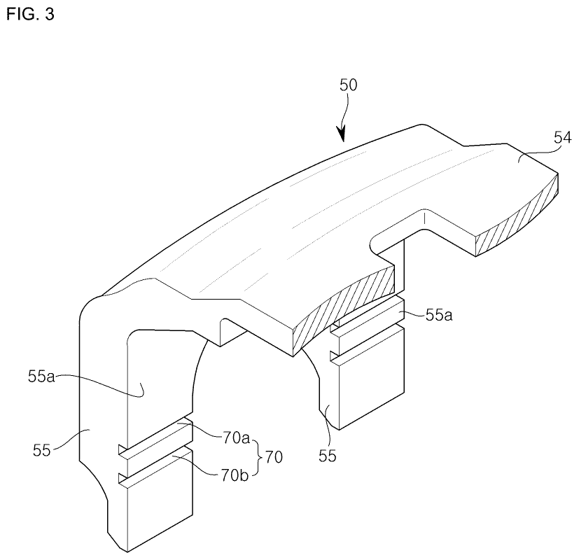

FIG. 1 is an exploded perspective view illustrating a brake apparatus according to one embodiment of the present disclosure, FIG. 2 is a cross-sectional view illustrating the brake apparatus according to one embodiment of the present disclosure, and FIG. 3 is a view illustrating a finger portion in which a concave portion is provided according to one embodiment of the present disclosure.

Referring to FIG. 1 to FIG. 3, a brake apparatus 10 in the present embodiment includes an inner pad assembly 20 and an outer pad assembly 30 which press both side surfaces of a disc 11 which rotates with a wheel, a carrier 40 which supports the inner pad assembly 20 and the outer pad assembly 30 so that the inner pad assembly 20 and the outer pad assembly 30 move forward or backward, a caliper housing 50 which is slidably installed on the carrier 40 so that the inner pad assembly 20 and the outer pad assembly 30 press the disc 11, and a pair of pad springs 60 which support the inner pad assembly 20 and the outer pad assembly 30 so that the inner pad assembly 20 and the outer pad assembly 30 slidably move.

As illustrated in FIGS. 1 to 3, the brake apparatus 10 may be positioned above the disc 11 and press the disc 11 to perform braking, but the brake apparatus 10 may be positioned in front of or behind the disc 11 to perform braking. Hereinafter, for the sake of convenience in the description, a configuration of the brake apparatus 10 will be described based on the brake apparatus 10 positioned above the disc 11. Hereinafter, a downward direction of the brake apparatus 10 is a direction from the brake apparatus 10 to a center of the disc 11, and a lateral direction of the brake apparatus 10 is a rotation direction at an upper side of the disc 11, that is, a front-rear direction of a vehicle in which the brake apparatus 10 is installed.

The disc 11 rotates with the wheel, and one outer side of the disc 11 may enter the inside of the carrier 40 coupled to a vehicle body.

The inner pad assembly 20 includes an inner pad plate 21 supported and slidably moved by the pad springs 60 and an inner friction pad 22 which is coupled to the inner pad plate 21 and comes into frictional contact with one surface of the disc 11.

Guide protrusions 23 supported by the pad springs 60 may protrude from both end portions of the inner pad plate 21.

The outer pad assembly 30 includes an outer pad plate 31 supported and slidably moved by the pad springs 60 and an outer friction pad 32 which is coupled to the outer pad plate 31 and comes into frictional contact with the other surface of the disc 11.

Guide protrusions 33 supported by the pad springs 60 may protrude from both end portions of the outer pad plate 31.

The carrier 40 includes a main beam 42, in which a knuckle hole 41 coupled to the vehicle body is formed, and a pair of guide beams 43 provided on both sides of the main beam 42.

The main beam 42 may be fixed to the vehicle body using a mounting bolt fastened to the knuckle hole 41. The main beam 42 may prevent deformation of the carrier 40 due to braking torque generated during braking.

Sliding grooves 44 corresponding to the guide protrusions 23 and 33 of the pad plates 21 and 31 and guide holes 45 to which the caliper housing 50 is coupled are formed in the guide beam 43.

The pad springs 60 are installed between the pad assemblies 20 and 30 and the carrier 40 to enable smooth movement and return of the pad plates 21 and 31 during braking.

The caliper housing 50 includes a main body 53 having a cylinder 51 for accommodating a piston 52, a bridge 54 extending from the main body 53 in the lateral direction, and a finger portion 55 extending downward from an end portion of the bridge 54.

The finger portion 55 may be provided as a pair of finger portions 55 extending downward from both sides of the bridge 54.

Ear portions 57 to which guide rods 56 are coupled are provided on both sides of the main body 53, and the guide rods 56 are inserted into the guide holes 45 provided in both ends of the carrier 40 and thus slidably installed on the carrier 40.

The piston 52 is installed to be movable forward and backward in the cylinder 51. The piston 52 is moved forward by a braking hydraulic pressure or driving of an actuator to press the inner pad assembly 20, and the caliper housing 50 is moved by a reaction force so that the finger portions 55 press the outer pad assembly 30 to the disc 11.

The finger portions 55 may be formed to be bent downward from end portions of the bridge 54 of the caliper housing 50 to surround the outer pad assembly 30 and provided as the pair of finger portions 55 disposed in parallel to press a left portion and a right portion of the outer pad assembly 30.

A concave portion 70 recessed inward to form paths through which air may flow may be provided in each of surfaces 55a of the finger portions 55 which come into contact with the outer pad assembly 30.

In this case, the concave portion 70 may form paths 70a and 70b elongated in one direction in the surface 55a, and one end portion of at least one of the paths 70a and 70b may extend to an edge of the surface 55a. Accordingly, since one end portion of at least one of the paths 70a and 70b extends to the edge of the surface 55a, even when the outer pad assembly 30 is in contact with the surface 55a, the end portions of the paths 70a and 70b form an inlet and an outlet for air. Due to such inlet and outlet, even when the outer pad assembly 30 is in contact with the surface 55a, external air may flow into the concave portion 70 through the end portions of the paths 70a and 70b.

In one embodiment of the present disclosure, in the concave portions 70, the paths 70a and 70b elongated in the lateral direction may be formed in the surface 55a. As described above, the brake apparatus 10 is positioned above the disc 11, and the lateral direction is the rotation direction at the upper side of the disc 11, that is, the front-rear direction of the vehicle in which the brake apparatus 10 is installed.

When the concave portion 70 elongates in one direction of the surface 55a of the finger portion 55, the concave portion 70 may elongate in the lateral direction to form the paths 70a and 70b in the rotation direction of the disk 11. Accordingly, an air flow generated by rotation of the disk 11 may move through the paths 70a and 70b formed in the rotation direction of the disk 11.

Air flows through the paths 70a and 70b formed between the outer pad assembly 30 and the surface 55a of the finger portion 55 to generate a negative pressure, and the negative pressure causes the outer pad assembly 30 to be adsorbed toward the finger portion 55. Accordingly, when braking of the brake apparatus 10 is released, the outer pad assembly 30 is separated from the disc 11 according to movement of the finger portion 55, and thus the occurrence of drag torque can be prevented.

Meanwhile, in one embodiment of the present disclosure, in the concave portion 70, two or more paths 70a and 70b spaced apart from each other may be formed in the surface 55a of the finger portion 55.

In the concave portion 70, two or more paths 70a and 70b spaced apart from each other may be formed so that negative pressures are formed at different positions and the outer pad assembly 30 is adsorbed toward the finger portion 55.

Meanwhile, as described above, the finger portions 55 may be provided as the pair of finger portions 55 disposed in parallel to press the left portion and the right portion of the outer pad assembly 30. In one embodiment of the present disclosure, the concave portion 70 may be provided to form paths in each of the pair of finger portions 55.

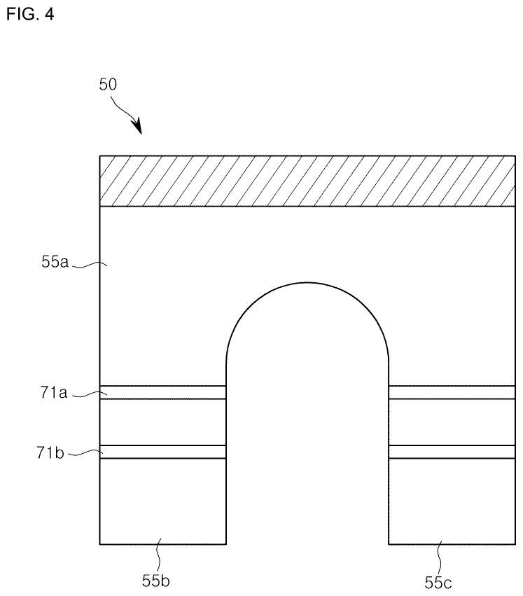

Hereinafter, a shape of a concave portion 70 according to various embodiments of the disclosure will be described with reference to FIGS. 4 to 8.

FIG. 4 is a view illustrating a path formed by a concave portion provided in a finger portion of a caliper housing according to one embodiment of the present disclosure.

As described above, two or more paths 71a and 71b spaced apart from each other may be formed by a concave portion 70. In one embodiment of the present disclosure, in the concave portion 70, two or more paths 71a and 71b have shapes recessed in parallel as illustrated in FIG. 4.

As illustrated in FIG. 4, in the concave portion 70, two or more paths 71a and 71b may be formed in each of surfaces 55a of a pair of finger portions 55b and 55c disposed in parallel to press a left portion and a right portion of an outer pad assembly 30, and two or more paths 71a and 71b may be in parallel.

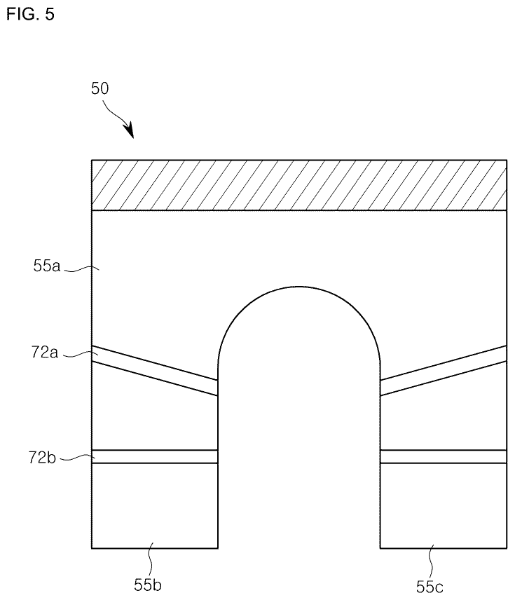

FIG. 5 is a view illustrating a path according to a second embodiment of the present disclosure.

As described above, two or more paths 72a and 72b spaced apart from each other may be formed by a concave portion 70. In the second embodiment of the present disclosure, in the concave portion 70, two or more paths 72a and 72b have shapes so that a predetermined angle is formed therebetween as illustrated in FIG. 5.

As illustrated in FIG. 5, in the concave portion 70, two or more paths 72a and 72b may be formed in each of surfaces 55a of a pair of finger portions 55b and 55c and disposed to form the predetermined angle therebetween. In this case, two or more paths 72a and 72b provided in each of the pair of finger portions 55b an d55c may form the predetermined angle so that a symmetrical shape is formed.

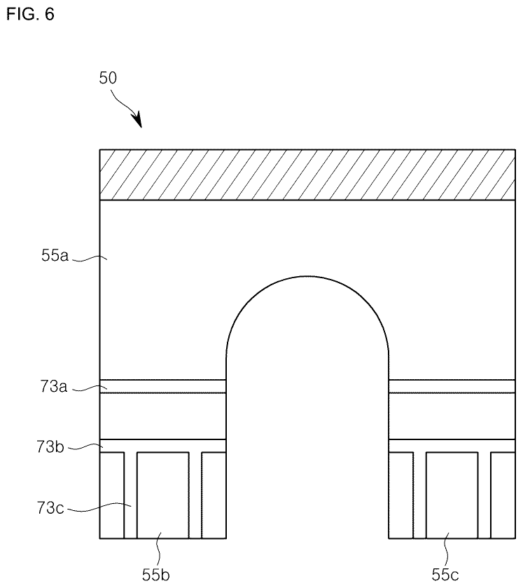

FIG. 6 is a view illustrating a path according to a third embodiment of the present disclosure.

In the third embodiment of the present disclosure, in a concave portion 70, lateral paths 73a and 73b having a shape recessed to elongate in a lateral direction and a downward path 73c having a shape recessed to elongate in a downward direction from the lateral path 73b may be formed in a surface 55a as illustrated in FIG. 6.

As illustrated in FIG. 6, the lateral paths 73a and 73b extending in the lateral direction and the downward path 73c extending in the downward direction may be formed in the concave portion 70. As illustrated in FIG. 6, in the concave portion 70, two or more lateral paths 73a and 73b may be formed, and the downward path 73c may be formed to elongate in the downward direction from one lateral path 73b. Two or more downward paths 73c may be branched off from one lateral path 73b.

Meanwhile, As illustrated in FIG. 6, in the concave portion 70 the lateral paths 73a and 73b and the downward paths 73c may be formed in the surface 55a of each of a pair of finger portions 55b and 55c.

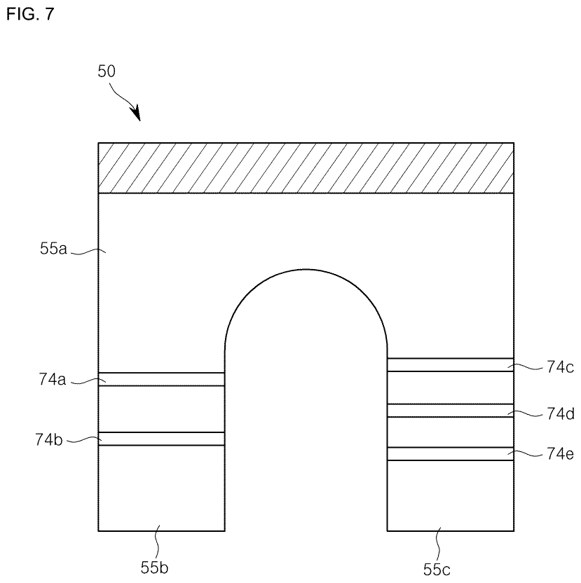

FIG. 7 is a view illustrating a path according to a fourth embodiment of the present disclosure.

As illustrated in FIGS. 4 to 6, the paths having linearly symmetrical shapes may be formed in the concave portions 70 of the pair of finger portions 55b and 55c. However, as in the fourth embodiment illustrated in FIG. 7, paths 74 having different shapes may be formed in a pair of finger portions 55b and 55c.

For example, the concave portions 70 having separated paths 74 of different numbers may be formed in the pair of finger portions 55b and 55c.

In the fourth embodiment illustrated in FIG. 7, two paths 74a and 74b spaced apart from each other may be formed in the concave portion 70 in a left finger portion 55b, and three paths 74c, 74d, and 74e spaced apart from each other may be formed in the concave portion 70 in a right finger portion 55c.

As described above, the paths 74 having different shapes may be formed by forming separated paths 74 of different numbers in the pair of finger portions 55b and 55c, however, in another embodiment, paths 74 having different shapes may be formed by forming paths 74 extending at different angles in a pair of finger portions 55b and 55c.

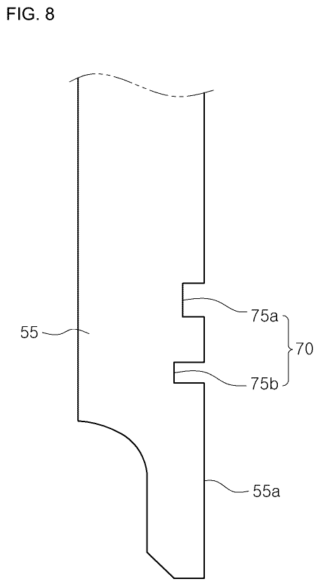

FIG. 8 is a view illustrating a path according to a fifth embodiment of the present disclosure.

As described above, two or more paths 75a and 75b separated from each other may be formed by a concave portion 70. In the concave portion 70, two or more paths 75a and 75b may have recessed shapes having different widths and depths as illustrated in FIG. 8.

In the fifth embodiment shown in FIG. 8, in the concave portion 70 recessed from a surface 55a of a finger portion 55 to form path 75, the path 75 may be formed to be recessed to have different widths and/or depths. As illustrated in FIG. 8, the path 75a formed at an upper side and the path 75b formed at a lower side may have different widths and different depths. Alternatively, in another embodiment, a path 75a formed at an upper side and a path 75b formed at a lower side may have the same depth and different widths, or may have the same depth and different widths.

In a disk brake caliper and a disk brake apparatus according to one embodiment of the present disclosure, an air path is formed by a concave portion in a surface of a finger portion of a caliper, which comes into contact with an outer pad assembly, to generate negative pressure, and thus the pad assembly can receive a force toward the finger portion and can be easily separated from a brake wheel.

Since a pad assembly is easily separated from a brake wheel, unnecessary wear can be prevented.

Since unnecessary wear is prevented, the generation of brake dust can be reduced.

Since unnecessary wear is prevented, unnecessary fuel consumption can be reduced.

The disclosed embodiments have been described with reference to the accompanying drawings as described above. It may be understood by those skilled in the art which the disclosure may be implemented in forms different from those of the disclosed embodiments without changing the technical spirit and essential features of the present disclosure. The disclosed embodiments are exemplary and should not be interpreted as purposes of limitation.

What is claimed is:

1. A brake caliper housing comprising
a main body having a cylinder in which a piston is accommodated;
a bridge extending from the main body in a lateral direction; and
a finger portion extending downward from an end portion of the bridge,
wherein a concave portion recessed inward to form a path through which air flows is formed in a surface of the finger portion in contact with an outer pad assembly.

2. The brake caliper housing of claim 1, wherein the concave portion is provided with a path elongated in one direction and formed in the surface, and at least one end portion of the path extends to an edge of the surface.

3. The brake caliper housing of claim 2, wherein the concave portion is provided with a path elongated in the lateral direction and formed in the surface.

4. The brake caliper housing of claim 1, wherein the concave portion is provided with two or more paths separated from each other and formed in the surface.

5. The brake caliper housing of claim 4, wherein the concave portion is provided with the two or more paths having shapes recessed in parallel.

6. The brake caliper housing of claim 4, wherein the concave portion is provided with the two or more paths having shapes recessed to have a predetermined angle therebetween.

7. The brake caliper housing of claim 4, wherein the concave portion is provided with the two or more paths having shapes recessed to have different widths and depths.

8. The brake caliper housing of claim 1, wherein the surface of the concave portion is provided with a lateral path having a shape recessed to elongate in the lateral direction and a downward path having a shape recessed to elongate in a downward direction from the lateral path.

9. The brake caliper housing of claim 1, wherein:
the finger portion is provided as a pair of finger portions disposed in parallel; and
the concave portion is provided with paths each formed in one of the pair of the finger portions.

10. The brake caliper housing of claim 9, wherein the concave portion is provided with paths having linearly symmetrical shapes and formed in the pair of the finger portions.

11. The brake caliper housing of claim 9, wherein the concave portion is provided with paths having different shapes and formed in the pair of the finger portions.

12. The brake caliper housing of claim 11, wherein the concave portion is provided with separated paths of different numbers formed in the pair of the finger portions.

13. A brake apparatus comprising:
a caliper housing including a main body having a cylinder in which a piston is accommodated, a bridge extending in a lateral direction from the main body, and a finger portion extending downward from an end portion of the bridge; and
a carrier in which the caliper housing is installed to be moved forward and backward,
wherein a concave portion recessed inward to form a path through which air flows is formed in a surface of the finger portion in contact with an outer pad assembly.

14. The brake apparatus of claim 13, further comprising an inner pad assembly and the outer pad assembly installed in the carrier to be moved forward and backward.

15. The brake apparatus of claim 13, wherein the concave portion is provided with a path elongated in one direction and formed in the surface, and at least one end portion of the path extends to an edge of the surface.

16. The brake apparatus of claim 15, wherein the concave portion is provided with a path elongated in the lateral direction and formed in the surface.

17. The brake apparatus of claim 13, wherein the concave portion is provided with two or more paths separated from each other and formed in the surface.

18. The brake apparatus of claim 17, wherein the concave portion is provided with the two or more paths having shapes recessed to have different widths and depths.

19. The brake apparatus of claim 13, wherein the concave portion is provided with a lateral path having a shape recessed to elongate in the lateral direction and a downward path having a shape recessed to elongate in a downward direction from the lateral path.

20. The brake apparatus of claim 13, wherein:
the finger portion is provided as a pair of finger portions disposed in parallel; and
the concave portion is provided with paths each formed in one of the pair of the finger portions.
